(19) United States
(12) Patent Application Publication
(10) Pub. No.: US 2015/0306598 A1
(43) Pub. Date: Oct. 29, 2015

(54) DEP Force Control And Electrowetting Control In Different Sections Of The Same Microfluidic Apparatus

(71) Applicant: Berkeley Lights, Inc., Emeryville, CA (US)

(72) Inventors: Igor Y. Khandros, Orinda, CA (US); J. Tanner Nevill, El Cerrito, CA (US); Steven W. Short, Pleasanton, CA (US); Ming C. Wu, Moraga, CA (US)

(73) Assignee: Berkeley Lights, Inc., Emeryville, CA (US)

(21) Appl. No.: 14/262,140

(22) Filed: Apr. 25, 2014

(51) Int. Cl. B01L 3/00

(52) U.S. Cl. CPC B01L 3/56

(57) ABSTRACT

A microfluidic apparatus can comprise a dielectrophoresis (DEP) configured section for holding a first liquid medium and selectively inducing net DEP forces in the first liquid medium. The microfluidic apparatus can also comprise an electrowetting (EW) configured section for holding a second liquid medium on an electrowetting surface and selectively changing a wetting property of the electrowetting surface. The DEP configured section can be utilized to select and move a micro-object in the first liquid medium. The EW configured section can be utilized to pull a droplet of the first liquid medium into the second liquid medium.

### CROSS REFERENCE TO RELATED APPLICATION(S)

This application is related to the U.S. patent application Ser. No. ______ entitled “Providing DEP Manipulation Devices And Controllable Electrowetting Devices In The Same Microfluidic Apparatus” (attorney docket no. BL45-US) filed Apr. 25, 2014, which is incorporated herein by reference in its entirety.

### BACKGROUND

Micro-objects, such as biological cells, can be processed in microfluidic apparatuses. For example, micro-objects suspended in a liquid in a microfluidic apparatus can be sorted, selected, and moved in the microfluidic apparatus. The liquid can also be manipulated in the device. Embodiments of the present invention are directed to improvements in selectively generating net DEP forces in a first section of a microfluidic apparatus and changing wetting properties of an electrowetting surface in another section of the microfluidic apparatus.

### SUMMARY

In some embodiments, an apparatus can include an enclosure, a dielectrophoresis (DEP) configuration, and an electrowetting (EW) configuration. The enclosure can comprise a first surface and an electrowetting surface. The DEP configuration can be configured to selectively induce net DEP forces in a first liquid medium disposed on the first surface, and the EW configuration can be configured to selectively change a wetting property of the electrowetting surface.

In some embodiments, a process of operating a fluidic apparatus can include inducing a net DEP force on a micro-object in a first liquid medium on a first surface in a first section of the apparatus. The process can also include changing a wetting property of a region of an electrowetting surface on which a second liquid medium is disposed in a second section of the apparatus.

In some embodiments, an apparatus can comprise an enclosure and a boundary. The enclosure can be configured to hold a first liquid medium disposed on a first surface in a first section of the enclosure and a second liquid medium disposed on an electrowetting surface in a second section of the enclosure, and the boundary can be between the first section and the second section of the enclosure. The first section of the enclosure can comprise a DEP configuration configured to induce selectively net DEP forces in the first liquid medium sufficiently to capture and move, relative to the first surface, micro-objects in the first liquid medium in the first section of the enclosure while connected to a biasing device. The second section of the enclosure can comprise an EW configuration configured to change selectively a wetting characteristic of regions of the electrowetting surface sufficiently to move a liquid droplet within the second medium in the second section of the enclosure while connected to a biasing device.

In some embodiments, a process of operating a fluidic apparatus can include drawing a droplet of a first liquid medium disposed on a first surface in a first section of an enclosure into a second medium disposed on an electrowetting surface in a second section of the enclosure. The foregoing drawing can include changing an electrowetting characteristic of a region of the electrowetting surface at a boundary with the first surface to induce a force at the region on the droplet to draw the droplet across the boundary and into the second liquid medium.

### BRIEF DESCRIPTION OF THE DRAWINGS

FIG. 1A is a perspective view of a microfluidic apparatus comprising sections for holding different liquid medium, inducing net dielectrophoresis (DEP) forces in one section and controlling an electrowetting property of a surface of another of the sections according to some embodiments of the invention.

FIG. 1B is a cross-sectional side view of the microfluidic apparatus of FIG. 1A.

FIG. 1C is a top view of the microfluidic apparatus of FIG. 1A with the cover removed.

FIG. 2 is a cross-sectional side view of the micro-fluidic device of FIG. 1A with liquid media in its sections and connected to biasing devices according to some embodiments of the invention.

FIG. 3 illustrates an example of a DEP configuration and a controllable electrowetting (EW) configuration of the enclosure of the device of FIG. 1A according to some embodiments of the invention.

FIG. 4 is an example of the electrode activation substrate of FIG. 3 configured as photoconductive material according to some embodiments of the invention.

FIG. 5 is another example of the electrode activation substrate of FIG. 3 configured as a circuit substrate according to some embodiments of the invention.

FIG. 6 illustrates another example of a DEP configuration and an EW configuration of the enclosure of the device of FIG. 1A according to some embodiments of the invention.

FIG. 7 is yet another example of a DEP configuration and an EW configuration of the enclosure of the device of FIG. 1A according to some embodiments of the invention.

FIG. 8 is a cross-sectional side view of a microfluidic apparatus with multiple stacked sections according to some embodiments of the invention.

FIG. 9 illustrates another example of an embodiment of a microfluidic apparatus with multiple stacked sections according to some embodiments of the invention.

FIG. 10A is a perspective view of an example of a microfluidic apparatus comprising a DEP configuration for manipulating micro-objects in a first section of the device and an EW configuration for manipulating droplets of a liquid medium on an electrowetting surface in a second section of the device according to some embodiments of the invention.

FIG. 10B is a side cross-sectional view of the microfluidic apparatus of FIG. 10A.

FIG. 10C is a top view of the microfluidic apparatus of FIG. 10A with the cover removed.

FIG. 11 is an example of a process for moving a micro-object from a first liquid medium in a first section of a microfluidic apparatus into a second liquid medium in a second section of the microfluidic apparatus according to some embodiments of the invention.

FIGS. 12A-21 show examples of performance of the process of FIG. 11 according to some embodiments of the invention.

FIG. 22 is an example of a process for culturing biological micro-objects in a microfluidic apparatus configured to hold multiple different liquid media according to some embodiments of the invention.

FIGS. 23-26 illustrate an example of performance of the process of FIG. 22 according to some embodiments of the invention.

FIG. 27 shows an example of a process that can be performed on the microfluidic apparatus of FIGS. 1A-1C or the microfluidic apparatus of FIGS. 10A-10C according to some embodiments of the invention.

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion. In addition, as the terms “on,” “attached to,” or “coupled to” are used herein, one element (e.g., a material, a layer, a substrate, etc.) can be “on,” “attached to,” or “coupled to” another element regardless of whether the one element is directly on, attached to, or coupled to the other element or there are one or more intervening elements between the one element and the other element. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent. The term “ones” means more than one.

As used herein, the term “micro-object” can encompass one or more of the following: inanimate micro-objects such as micro-particles, micro-beads, micro-wires, and the like; biological micro-objects such as cells (e.g., proteins, embryos, plasmids, oocytes, sperms, hydridomas, and the like); and/or a combination of inanimate micro-objects and biological micro-objects (e.g., micro-beads attached to cells).

The phrase “relatively high electrical conductivity” is used herein synonymously with the phrase “relatively low electrical impedance,” and the foregoing phrases are interchangeable. Similarly, the phrase “relatively low electrical conductivity” is used synonymously with the phrase “relatively high electrical impedance,” and the foregoing phrases are interchangeable.

A “fluidic circuit” means one or more fluidic structures (e.g., chambers, channels, holding pens, reservoirs, or the like), which can be interconnected. A “fluidic circuit frame” means one or more walls that define all or part of a fluidic circuit.

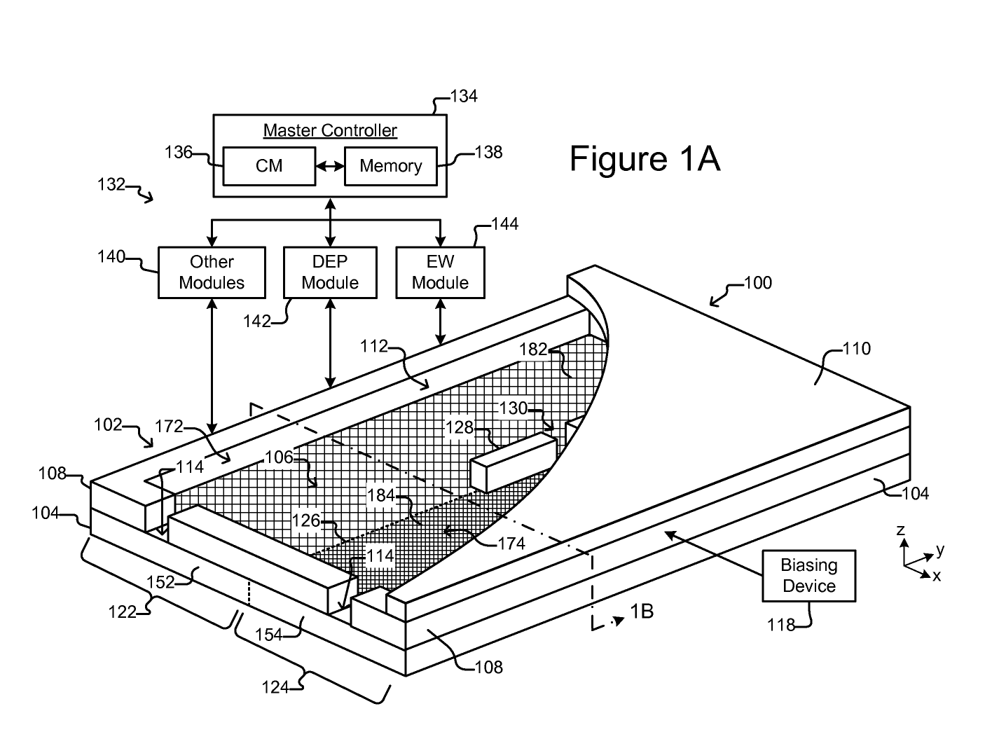

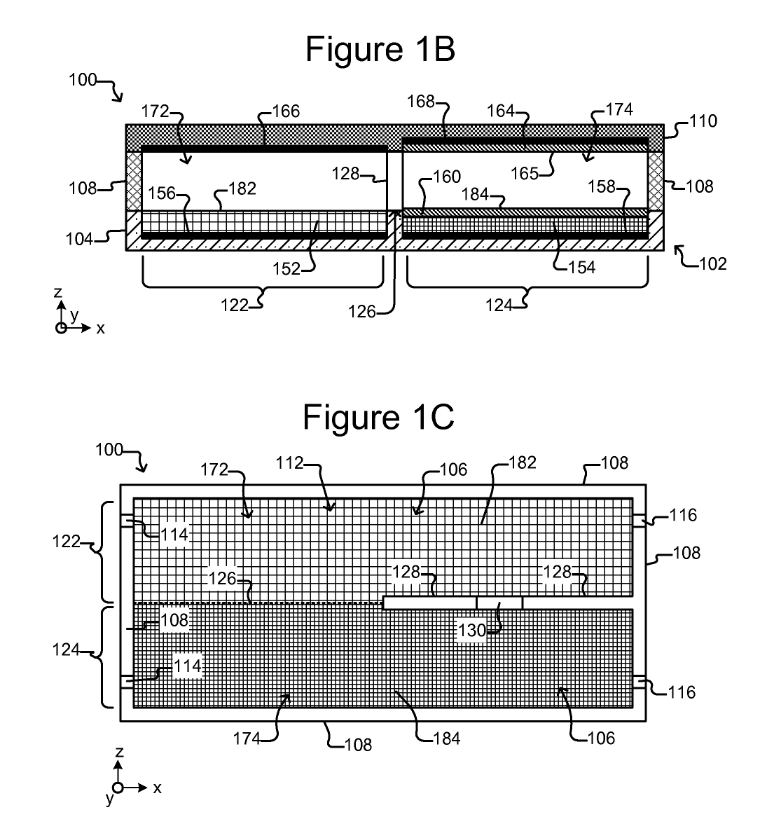

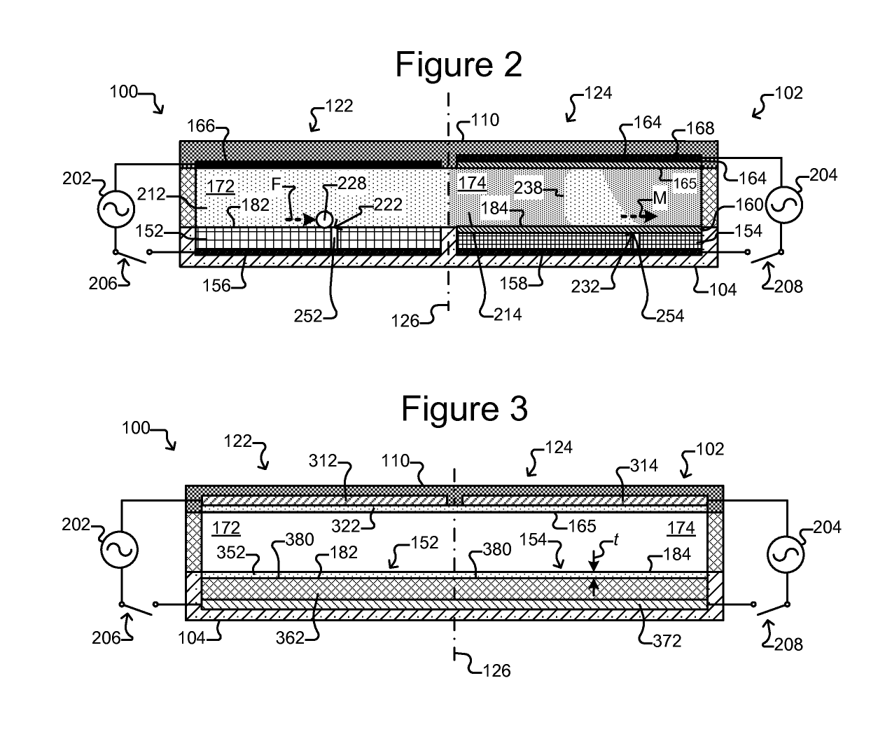

In some embodiments, a microfluidic apparatus can comprise a dielectrophoresis (DEP) configured section for holding a liquid medium and selectively inducing net DEP forces in the liquid medium. The microfluidic apparatus can also comprise an electrowetting (EW) configured section for holding another liquid medium on an electrowetting surface and selectively changing a wetting property of the electrowetting surface. FIGS. 1A-1C illustrate an example of such a microfluidic apparatus 100. FIG. 1A also illustrates examples of control equipment 132 for controlling operation of the apparatus 100.

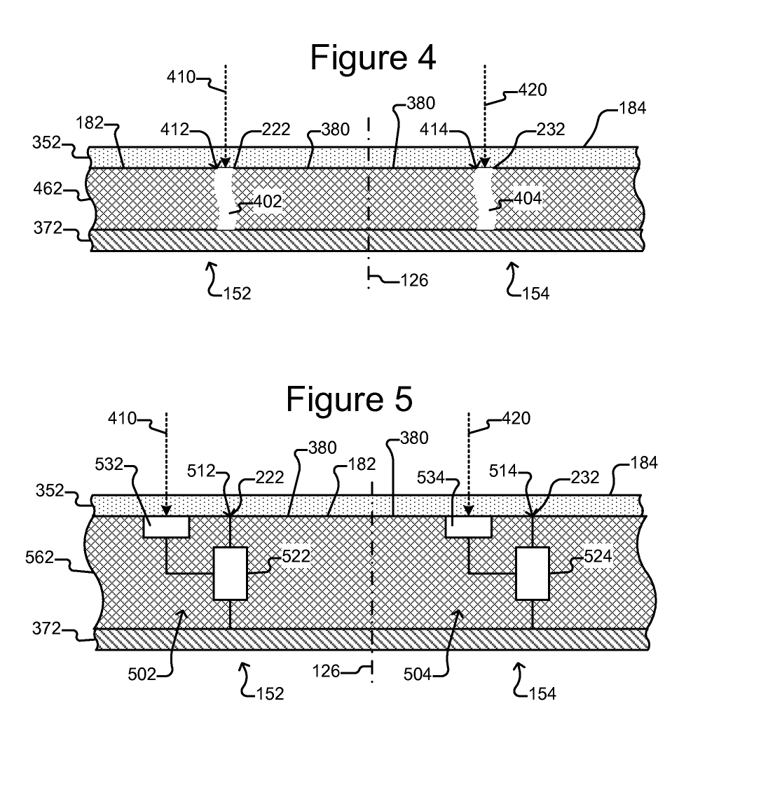

As shown, the apparatus 100 can comprise an enclosure 102, which can comprise a plurality (two are shown but there can be more) of sections 122, 124 each configured to hold a liquid medium (not shown in FIGS. 1A-1C but depicted as 212, 214 in FIG. 2). The first section 122 can comprise a first surface 182 and be further configured to selectively generate net DEP forces on micro-objects (not shown) in a liquid medium on the first surface 182. The first section 122 is thus referred to hereinafter as a DEP configured section or a DEP configuration 122 of the enclosure 102. The second section 124 can comprise an electrowetting surface 184 and can further be configured to selectively change a wetting property of the electrowetting surface 184. The second section 124 is thus referred to hereinafter as an electrowetting (EW) configured section or an EW configuration 124 of the enclosure 102.

Although the apparatus 100 can be physically structured in many different ways, in the example shown in FIGS. 1A-1C, the enclosure 102 is depicted as comprising a structure 104 (e.g., a base), a fluidic circuit frame 108, and a cover 110. As shown, the fluidic circuit frame 108 can be disposed on an inner surface 106 of the structure 104, and the cover 110 can be disposed over the fluidic circuit frame 108. With the structure 104 as the bottom and the cover as the top 110, the fluidic circuit frame 108 can define a fluidic circuit comprising, for example, interconnected fluidic chambers, channels, pens, reservoirs, and the like. Although the structure 104 is shown in FIGS. 1A and 1B as comprising the bottom of the apparatus 100 and the cover 110 is illustrated as the top, the structure 104 can be the top and the cover 110 can be the bottom of the apparatus 100.

In the example illustrated in FIGS. 1A-1C, the fluidic circuit frame 108 defines a chamber 112. A first section 172 of the chamber 112 corresponding to a DEP configured section 122 is hereinafter referred to as the first chamber section 172, and a second section of the chamber 112 corresponding to an EW section 124 of the enclosure 102 is hereinafter referred to as the second chamber section 174. As also shown, the chamber 112 can include one or more inlets 114 and one or more outlets 116.

In some embodiments, the enclosure 102 can comprise a physical barrier 128 between the first chamber section 172 and the second chamber section 174, and such a physical barrier 128 can comprise one or more passages 130 from the first chamber section 172 of the enclosure 102 to the second chamber section 174. In the example illustrated in FIGS. 1A-1C, such a physical barrier 128 is shown along only a portion of a boundary 126 between the first chamber section 172 and the second chamber section 174. Alternatively, the physical barrier 128 can extend the entirety of the boundary 126 or be located on a different portion of the boundary 126. Regardless, the physical barrier 128 can be part of the fluidic circuit frame 108 (as shown), or the physical barrier 128 can be structurally distinct from the fluidic circuit frame 108. Although one physical barrier 128 is shown, there can be more than one such physical barrier 128 disposed on the boundary 126.

The structure 104 can comprise, for example, a substrate or a plurality of interconnected substrates. The fluidic circuit frame 108 can comprise a flexible material (e.g. rubber, plastic, an elastomer, silicone, polydimethylsioxane (“PDMS”), or the like), which can be gas permeable. The cover 110 can be an integral part of the fluidic circuit frame 108, or the cover 110 can be a structurally distinct element (as illustrated in FIGS. 1A-1C). The cover 110 can comprise the same or different materials than the fluidic circuit frame 108. Regardless, the cover 110 and/or the structure 104 can be transparent to light.

As shown in FIG. 1B, in some embodiments, the DEP configuration 122 of the enclosure 102 can comprise a biasing electrode 156, a DEP section 152 of the structure 104, and the first surface 182, all of which can be part of the structure 104. The DEP configuration 122 can also include a biasing electrode 166, which can be part of the cover 110. The foregoing can be located with respect to each other as illustrated in FIG. 1B. The first surface 182 can be an outer surface of the DEP section 152 or an outer surface of one or more materials (e.g., one or more coatings) (not shown) disposed on the DEP section 152.

Similarly, the EW configuration 124 of the enclosure 102 can comprise a biasing electrode 158, an EW section 154 of the structure 104, a dielectric layer 160, and the electrowetting surface 184, all of which can be part of the structure 104. The EW configuration 124 can also include a hydrophobic surface 165, a layer 160 (e.g., a dielectric material), and a biasing electrode 168, all of which can be part of the cover 110. The foregoing can be located with respect to each other as shown in FIG. 1B. The electrowetting surface 184, which can be hydrophobic, can be an outer surface of the dielectric layer 160 or an outer surface of one or more materials (not shown) disposed on the dielectric layer 160. Similarly, the hydrophobic surface 165 can be an outer surface of the layer 164 or an outer surface of one or more materials (not shown) disposed on the layer 164.

As shown in FIG. 1A, an electrical biasing device 118 can be connected to the apparatus 100. The electrical biasing device 118 can, for example, comprise one or more voltage or current sources. As also shown in FIG. 1A, examples of the control equipment include a master controller 134, a DEP module 142 for controlling the DEP configuration 122 of the enclosure 102, and an EW module 144 for controlling the EW configuration 124 of the enclosure 102. The control equipment 132 can also include other modules 140 for controlling, monitoring, or performing other functions with respect to the apparatus 100.

The master controller 134 can comprise a control module 136 and a digital memory 138. The control module 136 can comprise, for example, a digital processor configured to operate in accordance with machine executable instructions (e.g., software, firmware, microcode, or the like) stored in the memory 138. Alternatively or in addition, the control module 136 can comprise hardwired digital circuitry and/or analog circuitry. The DEP module 142, EW module 144, and/or the other modules 140 can be similarly configured. Thus, functions, processes, acts, actions, or steps of a process discussed herein as being performed with respect to the apparatus 100 or any other microfluidic apparatus can be performed by one or more of the master controller 134, DEP module 142, EW module 144, or other modules 140 configured as discussed above.

FIG. 2 illustrates an example configuration of the apparatus 100. As shown, a first liquid medium 212 can be disposed on the first surface 182 in the first chamber section 172, and a second liquid medium 214 can be disposed on the electrowetting surface 184 in the second chamber section 174. The first liquid medium 212 and the second liquid medium 214 can be different mediums. For example, the second liquid medium 214 can be immiscible with respect to the first liquid medium 212. The first liquid medium 212 can be, for example, an aqueous medium (e.g., water), and the second liquid medium 214 can be immiscible in an aqueous medium. Examples of the second liquid medium 214 can include oil based media. Examples of suitable oils include gas permeable oils such as fluorinated oils. Fluorocarbon based oils are also examples of suitable oils.

As also shown in FIG. 2, a first biasing device 202 can be connected to the biasing electrodes 156, 166 of the DEP configuration 122 of the enclosure 102, and a second biasing device 204 can be connected to the biasing electrodes 158, 168 of the EW configuration 124 of the enclosure 102. The first biasing device 202 can be, for example, an alternating current (AC) voltage or current source, and the second biasing device 204 can similarly be an AC voltage or current source. A switch 206 can selectively connect the first biasing device 202 to and disconnect the first biasing device 202 from the DEP configuration 122. Another switch 208 can similarly connect the second biasing device 204 to and disconnect the second biasing device 204 from the EW configuration 124. The biasing devices 202, 204 and switches 206, 208 can be part of the biasing device 118 of FIG. 1A.

The DEP section 152 of the structure 104 can be configured to have a relatively high electrical impedance (i.e., low electrical conductivity) between the first medium 212 and the biasing electrode 156 except when an electrode 222 at the first surface 182 is activated. (The DEP section 152 can be an example of an electrode activation substrate.) Activating the electrode 222 can create a relatively low impedance (i.e., high conductivity) path 252 from the electrode 222 to the biasing electrode 156. While the electrode 222 is deactivated, the majority of the voltage drop due to the first biasing device 202 from the DEP biasing electrode 166 to the DEP biasing electrode 156 can be across the DEP section 152. While the electrode 222 is activated creating the relatively low impedance path 252, however, the majority of the voltage drop in the vicinity of the path 252 can be across the first medium 222, which can create a net DEP force F in the first medium 212 in the vicinity of the activated electrode 222. Depending on such characteristics as the frequency of the biasing device 202 and the dielectric properties of the first medium 212 and/or micro-objects 228 in the medium 212, the DEP force F can attract or repeal a nearby micro-object 228 in the first medium 212. Many electrodes like electrode 222 can be selectively activated and deactivated over some, most, or the entirety of the first surface 182. By selectively activating and deactivating such electrodes (like 222), one or more micro-objects 228 in the first medium 212 of the DEP section 152 of the enclosure 102 can be selected (e.g., captured) and moved in the medium 212. Equipment 132 (see FIG. 1A) can control activation and deactivation of such electrodes (e.g., 222). As will be seen, such electrodes (like 222) can be fixed or virtual.

The EW section of the structure 104 can similarly be configured to have a relatively high electrical impedance (i.e., low electrical conductivity) except when an electrode 232 at the electrowetting surface 184 is activated. (The EW section 154 can also be an example of an electrode activation substrate.) Activating such an electrode 232 can create a relatively low impedance (i.e., high conductivity) path 254 from the dielectric layer 232 to the EW biasing electrode 158. While the electrode 232 is deactivated (and the EW section 154 has a relatively high impedance), the voltage drop due to the second biasing device 204 from the EW biasing electrode 168 to the EW biasing electrode 158 can be greater across the EW section 154 than across the dielectric layer 160. While the electrode 232 is activated creating the relatively low impedance path 254, however, the voltage drop across the EW section 154 can become less than the voltage drop across the dielectric layer 160, which can change a wetting property of the electrowetting surface 184 in the vicinity of the activated electrode 232. As noted, the electrowetting surface 184 can be hydrophobic. The change in the wetting property can be to reduce the hydrophobic level of electrowetting surface 184 in the vicinity of the activated electrode 232. For example, a region of the electrowetting surface 184 in the vicinity of the activated electrode 232 can be changed from a first level of hydrophobicity to second level of hydrophobicity, which can be less than the first level. As another example, a region of the electrowetting surface 184 in the vicinity of the activated electrode 232 can be changed from hydrophobic to hydrophilic.

Many electrodes like electrode 232 can be selectively activated and deactivated over some, most, or the entirety of the electrowetting surface 184. By selectively activating and deactivating such electrodes (like 232), droplets of liquid medium 214 or another liquid (not shown) in the second liquid medium 214 can be moved M along the electrowetting surface 184. Equipment 132 (see FIG. 1A) can control activation and deactivation of such electrodes (e.g., 232). As will be seen, such electrodes (like 232) can be fixed or virtual.

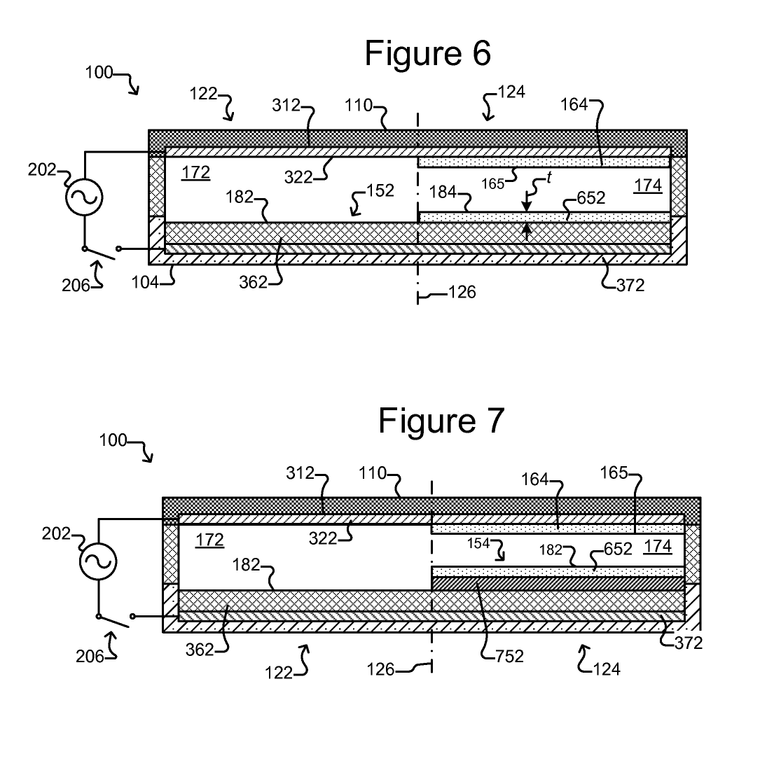

FIGS. 3-7 illustrate examples of the DEP configuration 122 and the EW configuration 124 of the enclosure 102.

In the examples shown in FIG. 3, the structure 104 of the enclosure 102 can comprise a layer 352 of dielectric material, an electrode activation substrate 362, and a biasing electrode 372. The first surface 182 can be a surface of the electrode activation substrate 362, and the electrowetting surface 184 can be an outer surface of the dielectric layer 352, which can be hydrophobic. As also shown, the cover 110 can comprise a DEP biasing electrode 312 and an EW biasing electrode 314. The cover 110 can also include a layer 322 of electrically insulating material, which can extend across the DEP section 122 and the EW section 124 as illustrated. Alternatively, layer 322 is disposed in the EW section 124 but does not extend into the DEP section 122, and of course, the layer 322 need not be present in some embodiments. The hydrophobic surface 165 can be an outer surface of the layer 322, which can be hydrophobic. The DEP biasing device 202 can be connected to the DEP biasing electrode 312 and the biasing electrode 372, and the EW biasing device 204 can be connected to the EW biasing electrode 314 and the biasing electrode 372.

Generally as shown in FIG. 3, each of the dielectric layer 352, the electrode activation substrate 362, and the biasing electrode 372 can be a continuous layer or substrate that extends across both the DEP section 172 and the EW section 174 of the chamber 112. For example, each of the dielectric layer 352, the electrode activation substrate 362, and the biasing electrode 372 can be a continuous layer or substrate that extends substantially the entirety of the structure 104. As also shown, the electrically insulating layer 322 of the cover 110 can also be a continuous layer that extends through both the DEP section 172 and the EW section 174 of the chamber 112. FIG. 3 depicts the DEP biasing electrode 312 and the EW biasing electrode 314 of the cover 110 as two different unconnected electrodes each corresponding to one but not the other of the DEP section 172 or the EW section 174. The DEP biasing electrode 312 and the EW biasing electrode 314 can alternatively be a continuous biasing electrode like the biasing electrode 372. Similarly, any of the insulating layer 322, the dielectric layer 352, the electrode activation substrate 362, and/or the biasing electrode 372 can be two distinct structures each corresponding to one but not the other of the DEP section 172 or the EW section 174 as the DEP biasing electrode 312 and EW biasing electrode 314 are depicted in FIG. 3. For example, the insulating layer 322 can be disposed only on the biasing electrode 314 in the EW section 124 but not on the biasing electrode 312 in the DEP section 122.

In the example shown in FIG. 3, the DEP biasing electrode 312 is an example of the electrode 166 in FIG. 2. Similarly, the portion of the electrode 372 to the left of the boundary 126 in FIG. 3 is an example of the electrode 156 in FIG. 2, and the portion of the electrode activation substrate 362 to the left of the boundary 126 is an example of the DEP section 152 in FIG. 2. Likewise, the EW biasing electrode 314 in FIG. 3 is an example of the electrode 168 in FIG. 2. The portion of the electrode activation substrate 362 to the right of the boundary 126 in FIG. 3 is an example of the EW section 154 in FIG. 2; the portion of the dielectric layer 352 in FIG. 3 to the right of the boundary 126 is an example of layer 160 in FIG. 2; and the portion of the insulating layer 322 in FIG. 3 to the right of the boundary 126 is an example of the layer 164 in FIG. 2.

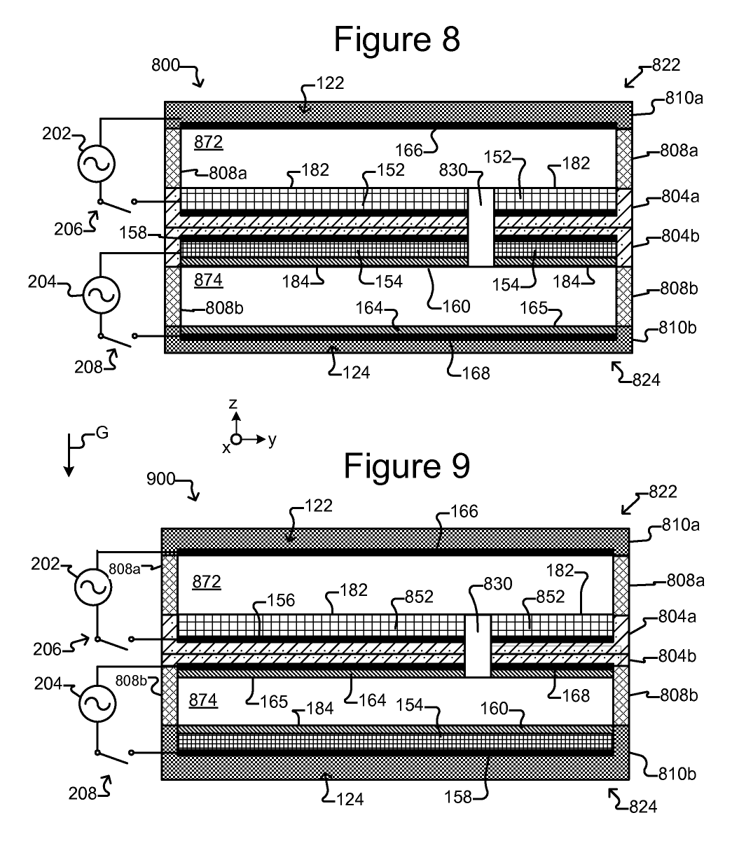

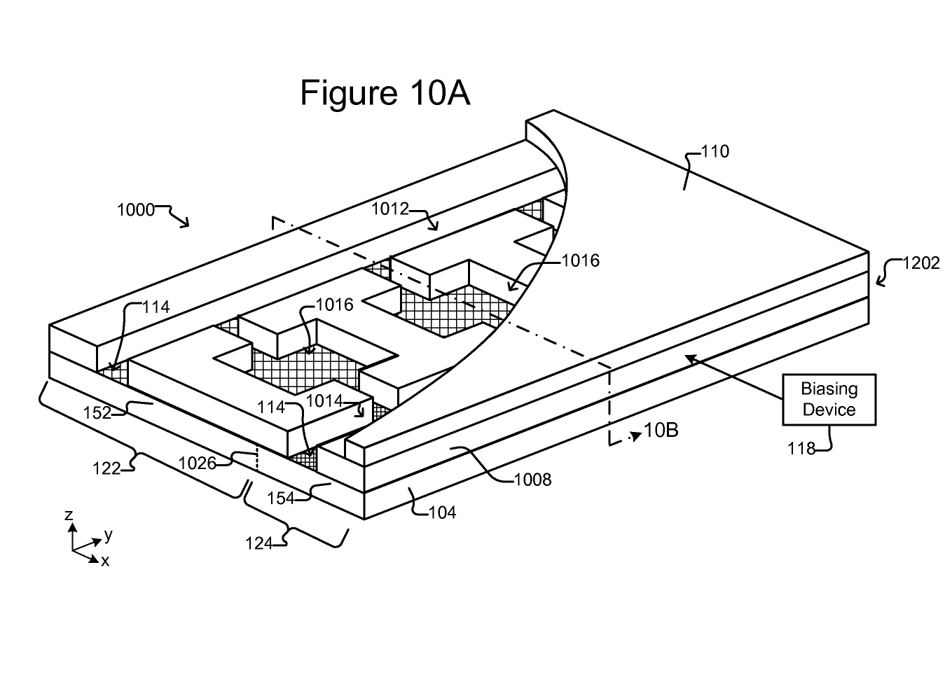

In the example shown in FIG. 2, the EW section 154 but not the DEP section 152 of the structure 104 is illustrated as comprising a dielectric layer 160, yet the example shown in FIG. 3 shows the dielectric layer 352 extending across both the DEP configuration 122 and the EW configuration 124 of the enclosure 102. In some embodiments, the thickness t of the dielectric layer 352 can be sufficiently thin that a DEP electrode like 222 (see FIG. 2) activated at an outer surface 380 of the electrode activation substrate 362 (e.g., at the region 412 in FIG. 4 or the region 512 in FIG. 5) can effectively form an electrical connection through the dielectric layer 352 with the first medium 212 in the first chamber section 172 of the enclosure 104. Alternatively or in addition, the DEP biasing device 202 can be operated such that the capacitive effect of the portion of the dielectric layer 352 to the left of the boundary 126 in FIG. 3 is effectively shorted, and the EW biasing device 204 can be operated such that the capacitive effect of the portion of the dielectric layer 352 to the right of the boundary 126 is not shorted.

For example, the portion of the dielectric layer 352 to the left of the boundary 126 in FIG. 3 can form a first effective capacitor (not shown) between the liquid medium 212 in the first chamber section 172 and any relatively high conductivity region (e.g., like an electrode 222 in FIG. 2) formed at the outer surface 380 of the electrode activation substrate 362. Similarly, the portion of the dielectric layer 352 to the right of the boundary 126 in FIG. 3 can form a second effective capacitor (not shown) between the liquid medium 214 in the second chamber section 174 and any relatively high conductivity region (e.g., like an electrode 232) formed at the outer surface 380 of the electrode activation substrate 362. The DEP biasing device 202 can be operated at a frequency f_{PM} that is sufficiently high to effectively short the first effective capacitor (not shown) and thus effectively eliminate the capacitive effect of the portion of the dielectric layer 352 to the left of the boundary 126 in FIG. 3. The EW biasing device 204, however, can be operated at a lower frequency f_{DM}, which can be a frequency at which the capacitive effect of the second effective capacitor (not shown) is significant.

The apparatus 100 can be operated in a DEP mode in which, for example, the switch 206 is closed connecting the DEP biasing device 202 to the biasing electrodes 312, 372 but the switch 208 is open disconnecting the EW biasing device 204 from the biasing electrodes 314, 372. The apparatus 100 can similarly be operated in an EW mode in which the switch 206 is open but the switch 208 is closed. The equipment 132 (see FIG. 1A) can control the switches 206, 208.

The electrode activation substrate 362 can be configured such that the electrodes 222, 232 (see FIG. 2) are virtual electrodes and/or fixed electrodes. FIG. 4 illustrates an example in which the electrode activation substrate 362 comprises photoconductive material 462, and the electrodes 222, 232 are virtual. FIG. 5 shows an example in which the electrode activation substrate 362 comprises a circuit substrate 562, and the electrodes 222, 232 are fixed.

As noted, in the example shown in FIG. 4, the electrode activation substrate 362 can comprise photoconductive material 462, which can be a material that has a relatively high electrical impedance except when exposed directly to light. As shown, when light 410 is directed onto a relatively small region 412 of the photoconductive material 462 of the DEP section 152 of the structure 104, a relatively high electrically conductive path 402 is formed at the region 412 through the photoconductive material 462 to the electrode 372. The conductive path 402 corresponds to the path 252 in FIG. 2, and the light 410 thus activates an electrode 222 at the region 412.

As also shown in FIG. 4, light 420 directed onto a relatively small region 414 of the EW section 154 of the structure 104 can similarly create a relatively high electrically conductive path 404 at the region 414 through the photoconductive material 462 to the electrode 372. The conductive path 404 corresponds to the path 254 in FIG. 2, and the light 420 thus activates an electrode 232 at the region 412.

Electrodes like electrode 222 can be activated in any desired pattern anywhere on the photoconductive material 462 by directing light 410 in the desired pattern onto the photoconductive material 462. Such electrodes 222 can be deactivated by removing the light 410. Electrodes like electrodes 232 can similarly be activated and deactivated in any desired pattern anywhere on the photoconductive material 462 in accordance with a pattern of the light 414. The electrodes 222, 232 are thus virtual electrodes. The DEP module 142 of FIG. 1A can comprise a light source (not shown), and the DEP module 142 and/or the master controller 134 can control the light source to direct changing patterns of light into the apparatus 100 to selectively activate and deactivate such electrodes 222, 232 anywhere on the photoconductive material 462.

In the example shown in FIG. 5, the electrode activation substrate 362 can comprise a circuit substrate 562, which can comprise a base material that has a relatively high electrical impedance but includes circuits for making relatively high conductive electrical connections through the substrate. For example, a DEP electrode circuit 502 in the DEP section 152 of the structure 104 can comprise a switch 522 that provides a high conductivity electrical connection (corresponding to the path 252 in FIG. 2) from a relatively small fixed region 512 through the substrate 562 to the biasing electrode 372. The switch 522 can be selectively opened and closed to thereby selectively create a high impedance path from the region 512 to the biasing electrode 372 or a high conductively path. In the example shown in FIG. 5, the switch 522 is controlled by a photo element 532, which can open and close the switch 522 in response to a directed light beam 410. Alternatively, the switch 522 can be controlled by an external control module (e.g., the DEP module 142 of FIG. 1A) by a control input (not shown). DEP electrode circuits like circuit 502 can be provided throughout the DEP section 152 of the structure 104, and a pattern of fixed electrodes like 222 can thus be provided through the DEP section 152. Such fixed electrodes 222 can be activated and deactivated with light 410 or through external control.

The DEP module 142 of FIG. 1A can comprise a light source (not shown), and the DEP module 142 and/or the master controller 134 can control the light source to direct changing patterns of light 410 into the apparatus 100 to selectively activate and deactivate such electrodes 222. Alternatively, if some or all of such electrodes 222 are hardwired, the DEP module 142 and/or the master controller 134 can selectively control activation and deactivation of such electrodes 222 in changing patterns.

The EW section 154 of the structure 104 can include similar EW electrode circuits 504. For example, an EW electrode circuit 504 in the EW section 154 of the structure 104 can comprise a switch 524 that provides a high conductivity electrical connection (corresponding to the path 254 in FIG. 2) from a relatively small fixed region 514 through the substrate 562 to the biasing electrode 372. The switch 524 can be selectively opened and closed to thereby selectively create a high impedance path from the region 514 to the biasing electrode 372 or a high conductively path. In the example shown in FIG. 5, the switch 524 is controlled by a photo element 524, which can open and close the switch 524 in response to a directed light beam 420. Alternatively, the switch 524 can be controlled by an external control module (e.g., the EW module 144 of FIG. 1A) by a control input (not shown). EW electrode circuits like circuit 504 can be provided throughout the EW section 154 of the structure 104, and a pattern of fixed electrodes like 232 can thus be provided throughout the EW section 154. Such electrodes 232 can be activated and deactivated with light 412 or through external control.

The EW module 144 of FIG. 1A can comprise a light source (not shown), and the EW module 144 and/or the master controller 134 can control the light source to direct changing patterns of light 420 into the apparatus 100 to selectively activate and deactivate such electrodes 232. Alternatively, if some or all of such electrodes 232 are hardwired, the EW module 144 and/or the master controller 134 can selectively control activation and deactivation of such electrodes 232 in changing patterns.

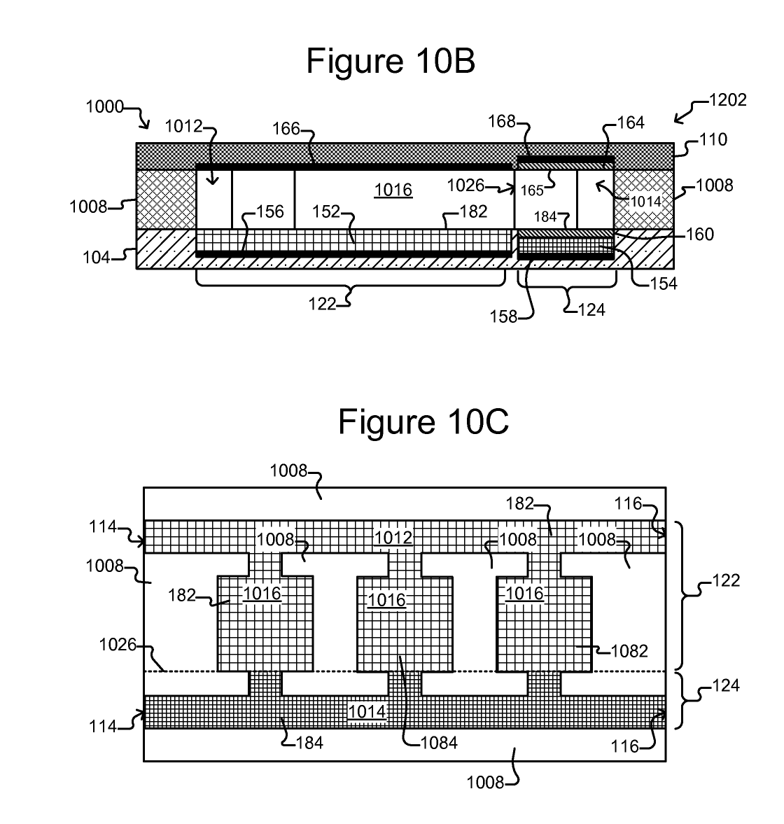

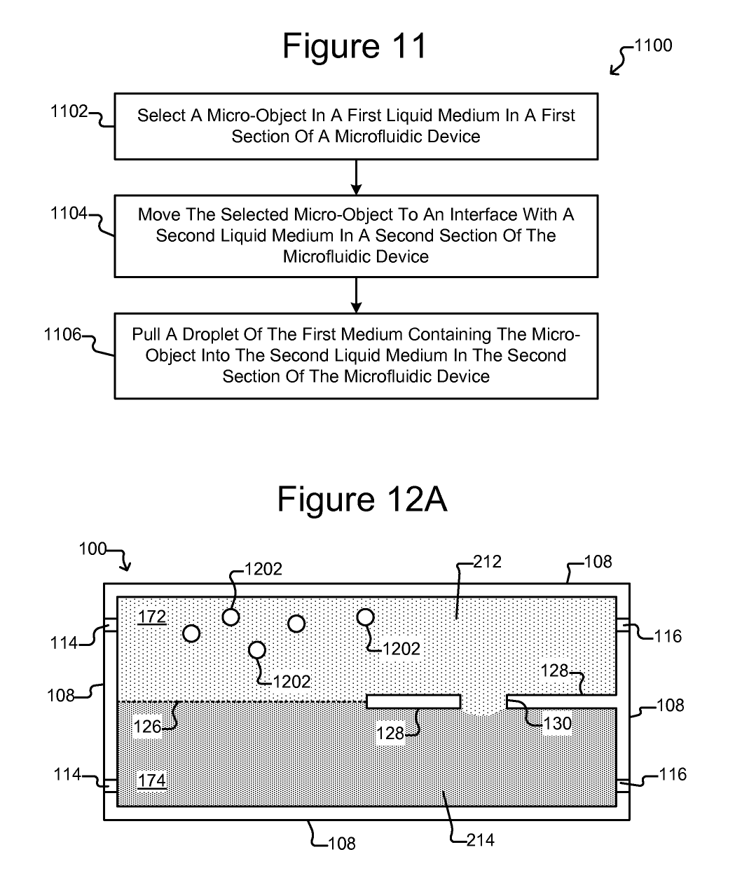

As noted, FIGS. 6 and 7, like FIG. 3, illustrate example configurations of the DEP configuration 122 and EW configuration 124 of the enclosure 102.

The configuration illustrated in FIG. 6 is similar to FIG. 3 except that a dielectric layer 652 replaces the dielectric layer 352. The dielectric layer 652 can form the electrowetting surface 184 of the second chamber section 174 but not the first surface 182 of the first chamber section 172. (See FIGS. 1A-2.) Thus, the dielectric layer 652 is part of the EW configuration 124 of the enclosure 104 but not the DEP configuration 122. Because the dielectric layer 652 does not extend across the first surface 182 of the DEP configuration 122, the thickness t of the dielectric layer 652 can be greater than the thickness t of the dielectric layer 352 in FIG. 2. Otherwise, the dielectric layer 652 can be like and can comprise the same materials as the dielectric layer 352.

The configuration of FIG. 7 is similar to FIG. 6 except the configuration of FIG. 7 includes an additional dielectric layer 752 between the dielectric layer 652 and the electrode activation substrate 362. The dielectric layer 652 and the dielectric layer 752 can be part of the EW configuration 124 of the enclosure 104, but those layers are not part of the DEP configuration 122.

Although not shown in FIG. 7, a biasing electrode (not shown) can be located in the EW section 124 between the additional dielectric layer 752 and the portion of the electrode activation substrate 362 that is in the EW section 124. The biasing device 204 (see FIG. 2) can be connected to the portion of the biasing electrode 312 (which can be bifurcated and thus comprise a portion in the DEP section 122 and a separate electrically isolated portion in the EW section 124) that is to the right of the boundary 126 in FIG. 7 and the biasing electrode (not shown) between the additional dielectric layer 752 and the portion of the electrode activation substrate 362 in the EW section 124 rather than to the biasing electrode 372 rather than the electrode 372.

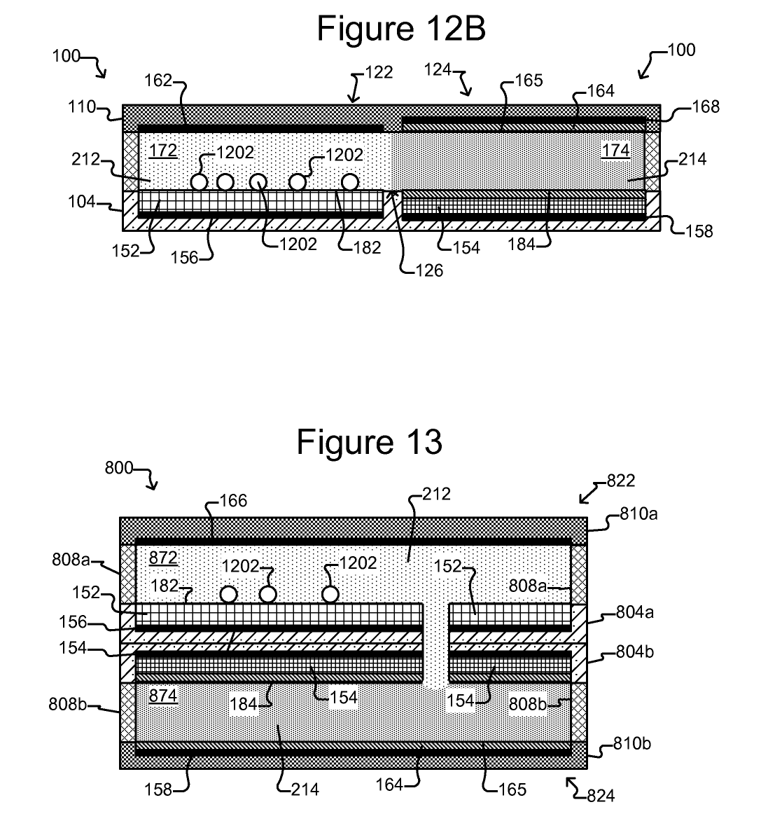

FIGS. 1A-1C show the first chamber section 172 and the second section 172 of the enclosure 104 side-by-side (e.g., substantially in a same plane). The foregoing, however, is merely an example, and other configurations are possible. FIG. 8 illustrates an example in which such sections are stacked.

FIG. 8 illustrates a microfluidic apparatus 800 that can comprise a first sub-enclosure 822 stacked on a second sub-enclosure 824. For example, each sub-enclosure 822, 824 can comprise a structure 804, a fluidic circuit frame 808, and a cover 810 each of which can be the same as or similar to the structure 104, fluidic circuit frame 108, and cover 110 of FIGS. 1A-1C. Although two stacked sub-enclosures 822, 824 are shown in FIG. 8, there can be more such stacked sub-enclosures.

Either or all of the sub-enclosures 822, 824 can be configured as a DEP configured device and/or an EW configured device. That is, although the first sub-enclosure 822 is illustrated as comprising a DEP configuration 122 and the second sub-enclosure 824 is shown as comprising an EW configuration 124, both sub-enclosures 822, 824 can comprise a DEP configuration (e.g., like 122) or an EW configuration (e.g., like 124). As yet another alternative, one or both of the sub-enclosures 822, 824 can be configured in part as a DEP configuration and in part as an EW configuration (e.g., one or both of the sub-enclosures 822, 824 can be configured like the apparatus 100 shown in FIGS. 1A-2).

As noted, in the example illustrated in FIG. 8, the first enclosure 822 can comprise a DEP configuration 122, and the second enclosure 824 can comprise an EW configuration 124 as discussed above. For example, the structure 804a of the first enclosure 822 can comprise the DEP section 152 including the first surface 182 and the cover 810a can comprise the biasing electrode 166 as discussed above. Similarly, the structure 804b of the second enclosure 822 can comprise the EW section 154, the dielectric layer 160, and the electrowetting surface 184, and the cover 810b can comprise the hydrophobic surface 165, the layer 164, and the biasing electrode 168 as discussed above.

The first sub-enclosure 822 can define a first section 872 for holding a liquid medium (e.g., the first liquid medium 212 shown in FIG. 2), and the DEP configuration 122 can select and manipulate micro-objects (e.g., like 228 in FIG. 2) in such a liquid medium in the first section 872. The second sub-enclosure 824 can similarly define a second section 874 for holding a liquid medium (e.g., the second liquid medium 214 shown in FIG. 2), and the EW configuration 124 can manipulate a liquid medium on the electrowetting surface 184, as discussed above, in the second section 874. As also shown, there can be one or more passages 830 (one is shown but there can be more) from the first section 872 to the second section 874. The sidewalls of such a passage 830 can be hydrophilic in which case an aqueous medium in the first section 872 can naturally enter and fill the passage 830. Alternatively, the sidewalls of the passage 830 can be hydrophobic.

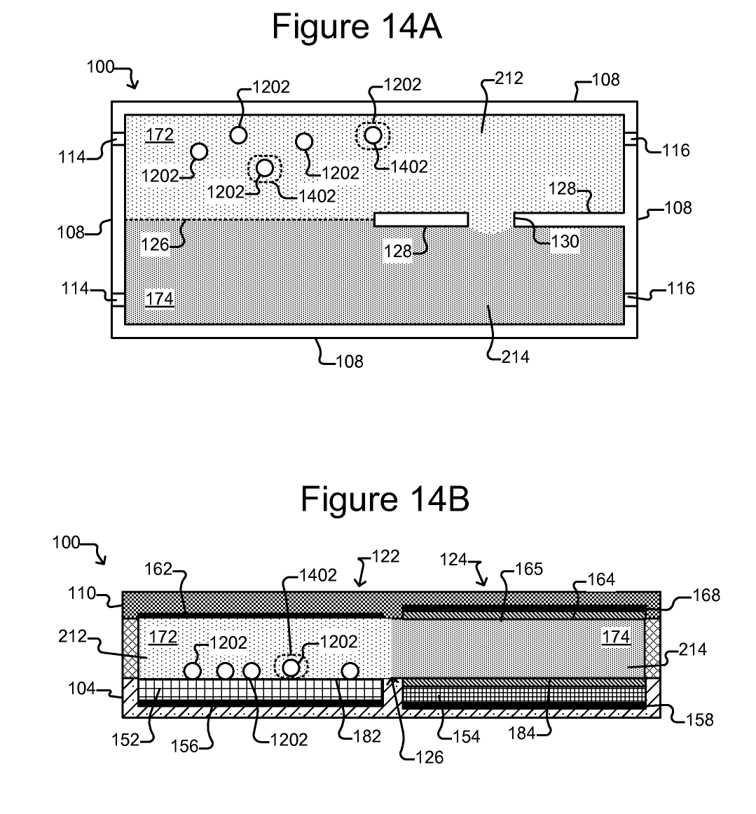

FIG. 9 illustrates another example of a microfluidic apparatus 900 that can be generally similar to the device 800 except that the positions of the biasing electrode 168, layer 164, and hydrophobic surface 165, on one hand, and the electrowetting surface 184, dielectric layer 160, EW section 154, and biasing electrode 158 are different (e.g., opposite) than the positions shown in FIG. 8.

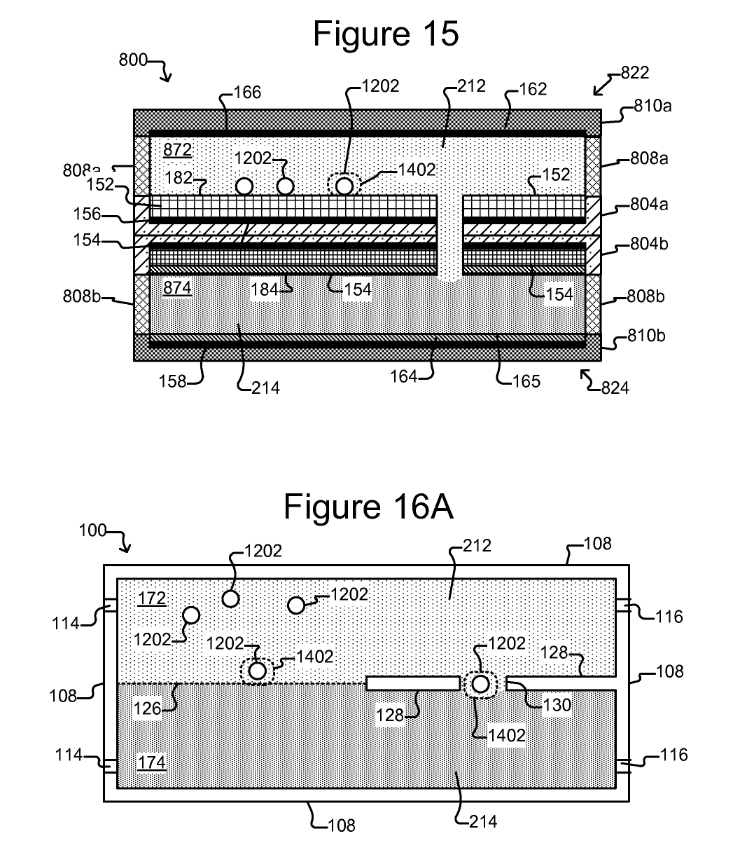

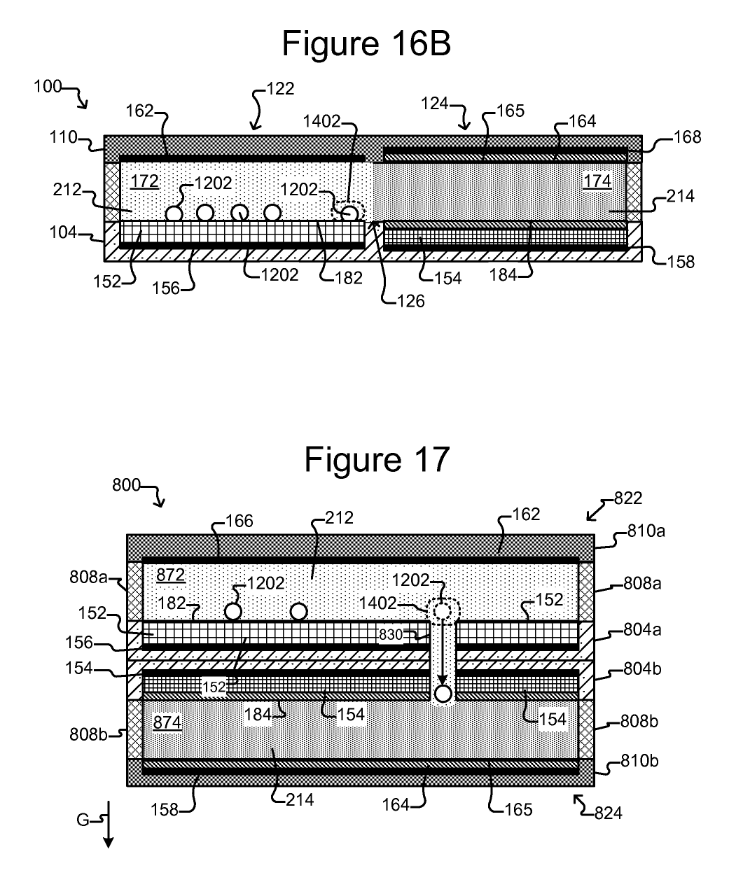

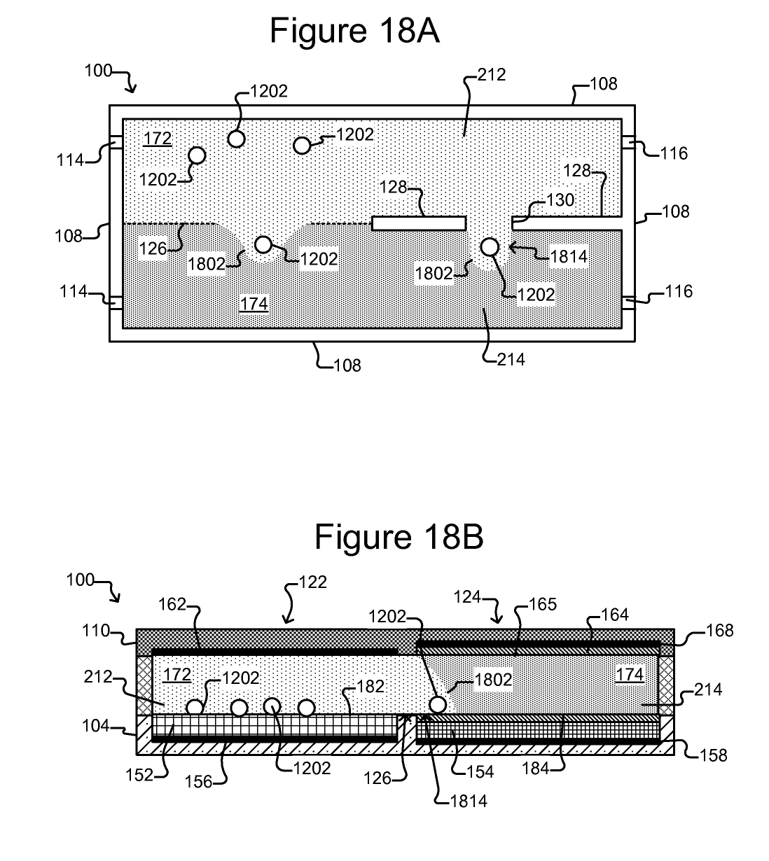

As mentioned, the configuration of the apparatus 100 shown in FIGS. 1A-1C as comprising a chamber 112 divided into a first chamber section 172 and a second chamber section 174 is an example, and many other configurations are possible. FIGS. 10A-10C illustrate an example of a microfluidic apparatus 1000 comprising multiple fluidic channels 1012, 1014 (two are shown but there can be more) and multiple holding pens 1016 (three are shown but there can be fewer or more) each of which can be connected to one or more of the channels 1012, 1014.

The apparatus 1000 can be generally similar to the apparatus 100, and like numbered elements in FIGS. 10A-10C can be the same as in FIGS. 1A-1C. The fluidic circuit frame 1008 of the apparatus 1000, however, can define, with the structure 104 and the cover 110, a first channel 1012, a second channel 1014, and holding pens 1016, which as shown, can be connected to the channels 1012, 1014. Otherwise, the fluidic circuit frame 1008 can be the same as or similar to the fluidic circuit frame 108.

In the example shown in FIGS. 10A-10C, the first channel 1012 and the pens 1016 can be configured to hold a first liquid medium (not shown but can be the first liquid medium 212 of FIG. 2), and the structure 104 and cover 110 can include the DEP configuration 122 for selecting and manipulating micro-objects in the first liquid medium. For example, the structure 104 can comprise the biasing electrode 156, DEP section 152, and first surface 182, and the cover 110 can comprise the biasing electrode 166, all of which can be as discussed above. Similarly, the structure 104 can also comprise the biasing electrode 158, EW section 154, dielectric layer 160, and electrowetting surface 184, and the cover 110 can also comprise the hydrophobic surface 165, layer 164, and biasing electrode 168, all of which can be as discussed above. As discussed above, the DEP configuration 122 can be for selecting and manipulating micro-objects (e.g., 228) in a first liquid medium (e.g., 212) on the first surface 182 in the first channel 1012 and pens 1016, and the EW configuration 124 can be for manipulating a liquid medium (not shown) on the electrowetting surface 184 in the second channel 1014.

In FIGS. 10A-10C, the boundary 1026 can be the same as the boundary 126 in FIGS. 1A-1C: the boundary 1026 is the boundary between the first surface 182 and the electrowetting surface 184, which can be the boundary between a first section (comparable to the first chamber section 172 of FIGS. 1A-1C) comprising the first channel 1012 and the pens 1016 and a second section (comparable to the second chamber section 174 of FIGS. 1A-1C) comprising the second channel 1014. Although not shown in FIGS. 10A-10C or in FIGS. 8 and 9, the equipment 132 and biasing device 118 (e.g., comprising the biasing devices 202, 204 and switches 206, 208 of FIG. 2) of FIGS. 1A-1C can bias, control, and provide miscellaneous functions to the devices 800, 900, and 1000 of FIGS. 8-10C.

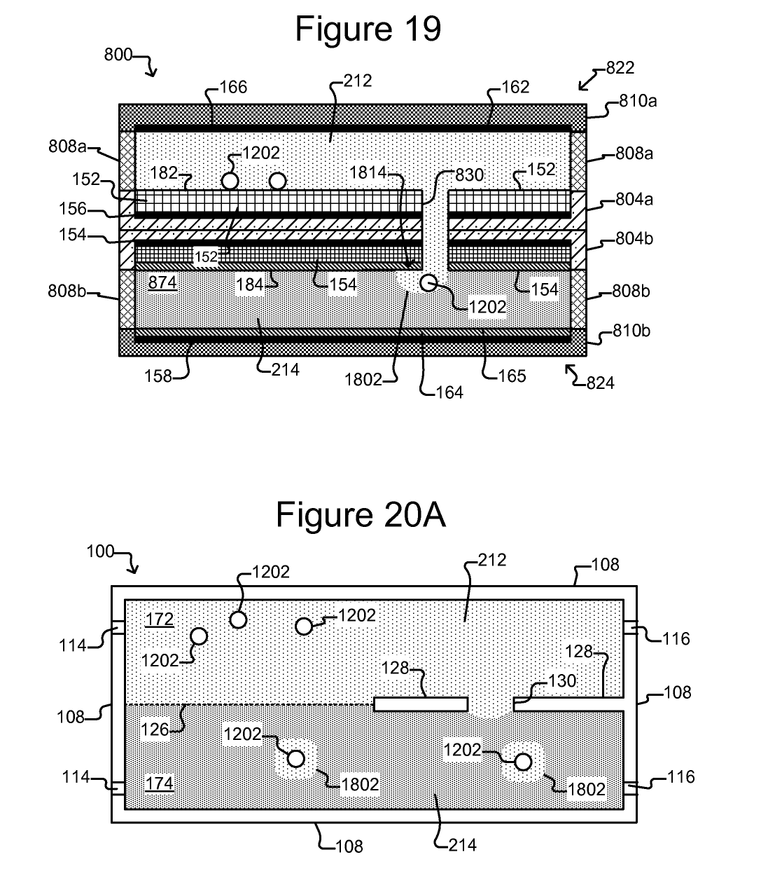

FIG. 11 is an example of a process 1100 for moving a micro-object from a first liquid medium in a microfluidic apparatus to a second liquid medium. For ease of illustration and discussion, the process 1100 is discussed below with respect to the apparatus 100 of FIGS. 1A-1C and the device 800 of FIG. 8. The process 1100 is not so limited, however, but can be performed on other microfluidic apparatuses such as the device 900 of FIG. 9, the apparatus 1000 of FIGS. 10A-10C, or other such devices.

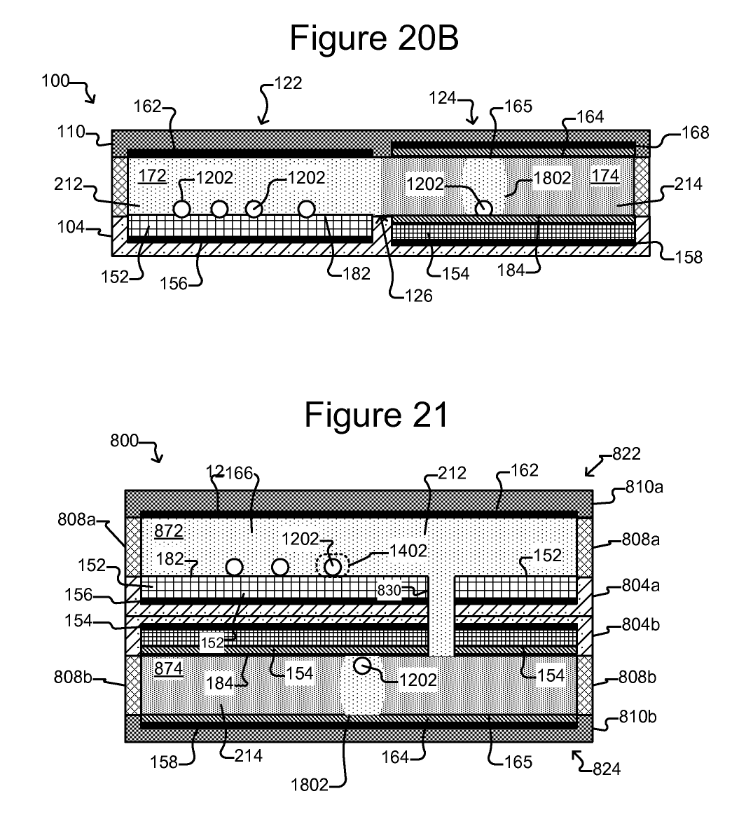

As shown, at step 1102, the process 1100 can select a micro-object in a DEP configured portion of a microfluidic apparatus. FIGS. 12A-15 illustrates examples.

FIG. 12A shows a top view with the cover 110 removed and FIG. 12B is a across-sectional side view of the apparatus 100 corresponding to FIGS. 1C and 1B but with the first liquid medium 212 in the first chamber section 172 of the enclosure 102 and the second liquid medium 214 in the second chamber section 174 (as illustrated in FIG. 2). In addition, micro-objects 1202 (which can be like the micro-object 218 of FIG. 2) can be suspended in the first liquid medium 212 in the first chamber section 172. FIG. 13 shows the device 800 of FIG. 8 with the first liquid medium 212 in the first section 872 of the first sub-enclosure 822 and the second liquid medium 214 in the second section 874 of the second sub-enclosure 824. Micro-objects 1202 are also shown in the first medium 212 in the first section 872. Although not shown in FIGS. 12A-21, the equipment 132 and biasing device 118 (e.g., comprising the biasing devices 202, 204 and switches 206, 208 of FIG. 2) of FIGS. 1A-1C can bias, control, and provide miscellaneous functions to the devices 100 and 800 illustrated in FIGS. 12A-21. Indeed, the master controller 134 can be configured to perform one, some, or all of the steps of the process 1100.

As shown in FIGS. 14A and 14B, one or more of the micro-objects 1202 in the first liquid medium 212 can be selected and captured with a DEP trap 1402. The DEP traps 1402 can be created by activating one or more electrodes 222 (not shown in FIGS. 14A and 14B) at the first surface 182 of the DEP section 152 (as discussed above with respect to FIG. 2) around a selected micro-object 1202 to capture the micro-object 1202. A specific one or more of the micro-objects 1202 can be identified and selected from a group of micro-objects 1202 in the first chamber section 172 based on any of a number of characteristics. Similarly, as shown in FIG. 15, one or more specific micro-objects 1202 can be identified and selected with a DEP trap 1402 in the first section 872 of the device 800.

Returning again to FIG. 11, at step 1104, the process 1100 can move the one or more micro-objects selected at step 1102 to an interface with the second liquid medium in the device. FIGS. 16A-17 illustrate examples.

As shown in FIG. 16A, a selected micro-object 1202 can be moved in the apparatus 100 to the passage 130 through the physical barrier 128. As another example and as shown in FIGS. 16A-16B, a selected micro-object 1202 can also be moved to a portion of the boundary 126 that does not have a physical barrier. The selected micro-objects 1202 can be moved in the first liquid medium 212 in the first chamber section 172 in the apparatus 100 by moving the traps 1402, which can be accomplished by activating and deactivating electrodes 222 (not shown in FIGS. 16A and 16B) on the first surface 182 of the DEP section 152 as discussed above.

As still another example illustrated in FIG. 17, a selected micro-object 1202 in the first section 872 of the device 800 can be moved to the passage 830, where the selected micro-object 1202 can be released into the passage 830. The selected micro-objects 1202 can be moved to the passage 830 by moving the trap 1402 to the passage, which can be accomplished by activating and deactivating electrodes 222 (not shown in FIG. 17 on the first surface 182 of the DEP section 152 as discussed above with respect to FIG. 2. The selected micro-object 1202 can be released by deactivating electrodes 222 of the trap 1402.

The force of gravity G can move the released micro-object 1202 to the bottom of the passage 830 at the interface with the second liquid medium 214 in the second section 874. Alternatively, the released micro-object 1202 can be moved down the passage 830 by forces other than gravity G. For example, a flow of the first liquid medium 212 in the passage 830 can move the released micro-object 1202 down the passage 830. As another example, the micro-object 1202 can be moved down the passage 830 by the DEP trap 1402.

Referring again to FIG. 11, at step 1106, the process 1100 can pull a droplet of the first liquid medium containing the micro-object from the first liquid medium 212 into the second medium. FIGS. 18A-19 illustrate examples.

As shown in FIG. 18A, a droplet 1802 of the first liquid medium 212 with a micro-object 1202 can be pulled from the first chamber section 172 through the passage 130 in the physical barrier 128 of the apparatus 100 into the second liquid medium 214 in the second chamber section 174 of the apparatus 100. As another example illustrated in FIGS. 18A and 18B, such a droplet 1802 can be pulled into the second medium 214 from the first medium 212 across a portion of the boundary 126 where there is no physical barrier 128. Regardless, a droplet 1802 of the first liquid medium 212 can be pulled from the first chamber section 172 into the second liquid medium 214 in the second chamber section 174 by activating electrodes 232 (not shown in FIGS. 18A and 18B) on the electrowetting surface 184 in a region 814 adjacent the boundary 126 between the first and second liquid media 212, 214 generally as discussed above with respect to FIG. 2. As noted in the discussion of FIG. 2 above, active electrodes 232 on the electrowetting surface 184 can attract the first liquid medium 212 and thereby move a droplet of the first liquid medium 212 along the electrowetting surface 184. Another example is shown in FIG. 19, which shows an example of drawing a droplet 1802 of the first medium 212 from the passage 830 into the second medium 214 in the second section 874.

Additional actions can be taken to aid in pulling a droplet 1802 from the first chamber section 172 into the second chamber section 174. For example, a pressure differential can be created that tends to draw a droplet 1802 from the first chamber section 172 into the second chamber section 174. Such a pressure differential can aid in pulling the droplet 1802 into the second chamber section 874 and can thus be utilized in conjunction with activating electrodes 232 as discussed above. Such a pressure differential can be induced hydrodynamically, by a piezo device, utilizing air pressure, utilizing liquid pressure, or the like. Rather than aiding in pulling a droplet 1802 into the second chamber section 174, inducing a pressure differential can be utilized to pull the droplet 1802 into the second chamber section 174 without activating electrodes 232. Pressure and/or other techniques can thus be utilized to aid in pulling a droplet 1802 into the second chamber section 174, or such techniques can be utilized to pull a droplet 1802 into the second chamber section 174 without activating electrodes 232.

Although not shown in FIGS. 18A and 18B, additional elements can be included. For example, a moveable cutting tool (e.g., comprising a knife blade) can be provided in the chamber 112 and configured to separate a droplet 1802 in the second chamber section 174 from the medium 212 in the first chamber section 172.

As shown in FIGS. 20A and 20B, the droplets 1802 of the first liquid medium 212 pulled into the second medium 214 can be moved about with the micro-objects 1202 in the droplets 1802 in the second chamber section 174, which can be done by selectively activating and deactivating electrodes 232 (not shown in FIGS. 20A and 20B) at a region of the electrowetting surface 184 that is immediately adjacent (e.g., in front of) the droplet 1802 generally as discussed above with respect to FIG. 2. As shown in FIG. 21, the droplets 1802 can similarly be moved about in the second liquid medium 214 in the second section 874.

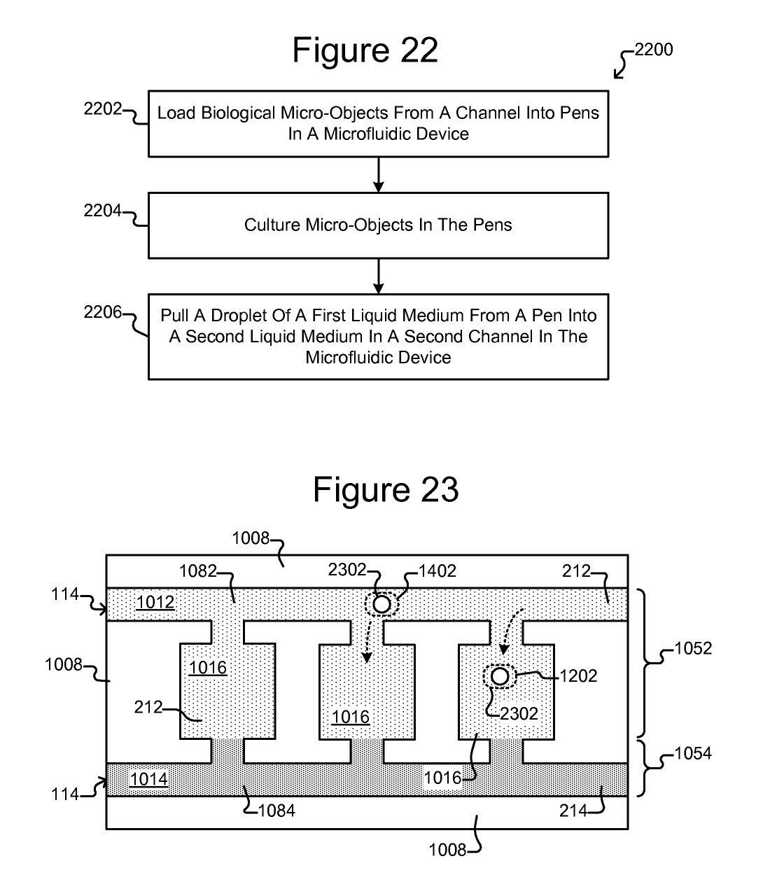

FIG. 22 is an example of a process 2200 for culturing biological micro-objects in a microfluidic apparatus. For ease of illustration and discussion, the process 2200 is discussed below with respect to the apparatus 1000 of FIGS. 10A-10C. The process 2200 is not so limited, however, but can be performed with other microfluidic apparatuses.

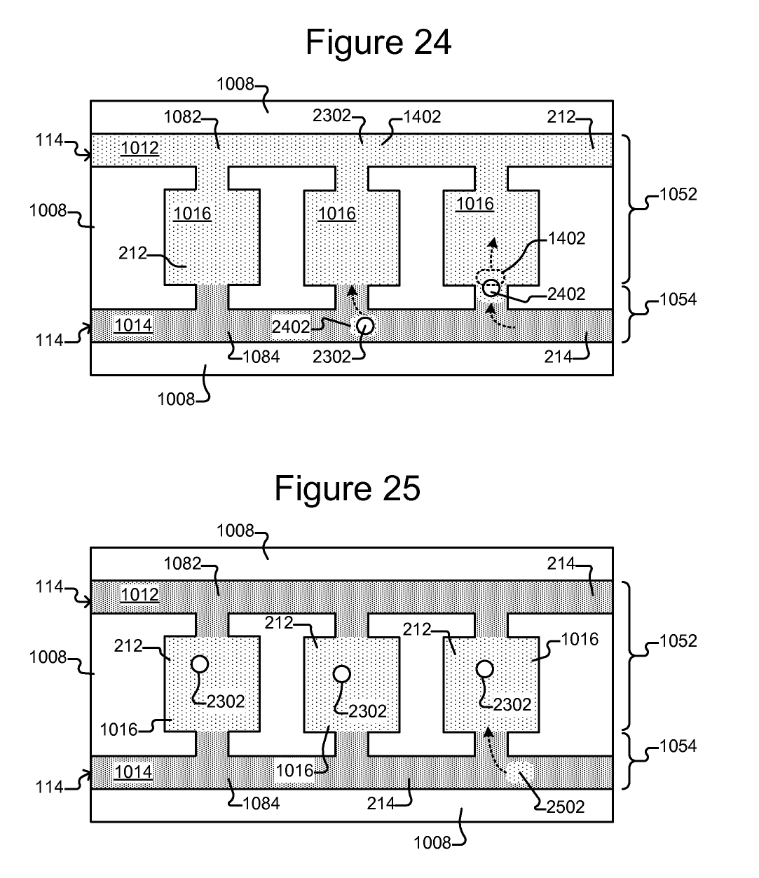

Although not shown in FIGS. 23-25, the equipment 132 and biasing device 118 (e.g., comprising the biasing devices 202, 204 and switches 206, 208 of FIG. 2) of FIGS. 1A-1C can bias, control, and provide miscellaneous functions to the apparatus 1000 illustrated in FIGS. 23-25. The master controller 134 can be configured to perform one, some, or all of the steps of the process 2200.

As shown, at step 2202, the process 2200 can load biological micro-objects into holding pens in a micro-fluidic device. Examples are illustrated in FIGS. 23 and 24, which show top views of the apparatus 1000 of FIGS. 10A-10C with the cover 110 removed corresponding to FIG. 10C. In FIGS. 23 and 24, the first channel 1012 and the pens 1016 contain the first liquid medium 212 and the second channel 1014 contains the second liquid medium 214.

As shown in the example of FIG. 23, biological micro-objects 2302 can be selected in the first channel 1012 and moved into the pens 1016. As also shown, a particular biological micro-object 2302 can be selected and moved by trapping the particular micro-object 2302 with a DEP trap 1402 and moving the DEP trap 1402 as discussed above with respect to FIG. 11.

In the example shown in FIG. 24, biological micro-objects 2302 can be introduced (e.g., through an inlet 114) into the second channel 1014. As shown, one or more of the micro-objects 2302 can be inside droplets 2402 of a medium (e.g., the first medium 212) in the second channel 1014. Those droplets 2402 can be moved to openings of the pens 1016 generally as shown. The droplets 2402 can be moved in the second medium 214 generally as discussed above. Once a droplet 2402 is moved to an interface between the first medium 212 and the second medium 214 at an opening to a pen 1016, the one or more biological micro-objects 2302 can be moved from the droplet 2402 in the second medium 214 into the first medium 212 in the pen 1016. For example, a particular biological micro-object 2302 in a droplet 2402 at the interface between the first medium 212 and the second medium 214 can be selected and moved by trapping the particular micro-object 2302 with a DEP trap 1402 and moving the DEP trap 1402 (as discussed above with respect to FIG. 11) into the pen 1016. As noted, DEP traps 1402 that attract a micro-object 2402 can be generated in the DEP section 1052, which can thus attract a micro-object 2402 sufficiently to pull the micro-object 2402 across the interface between the first medium 212 and the second medium 214.

Regardless of how the biological objects 2302 are loaded into pens 1016 at step 2202, at step 2204, the process 2200 can culture the micro-objects 2302 in the pens 1016. For example, once one or more micro-objects 2302 are placed into each pen 1016, the micro-objects can be left for a time to grow, produce biological material, or the like. Nutrients can be provided to the micro-objects 2302 in the pens in a flow (not shown) of the first medium 212 in the first channel 1012. As another example, as shown in FIG. 25, once micro-objects 2302 are in the pens 1016, the first liquid medium 212 can be replaced in the first channel 1012 with the second liquid medium 214. This can keep the micro-objects 2302 from escaping the pens 1016 into the first channel 1012. Nutrients can be provided to the micro-objects 2302 in the pens 1016 by moving droplets 2502 of the first liquid medium 212 through the second liquid medium 214 in the second channel 1014 into the pens 1016. Such droplets 2502 can contain nutrients for the micro-objects 2302 in the pens 1016. The droplets 2502 can be moved in the second channel 1014 in the same way that droplets 1802 are moved as discussed above with respect to FIGS. 18A-21.

At step 2206, the process 2200 can pull droplets of the first liquid medium from the pens into the second channel. For example, as shown in FIG. 26, an aliquot in the form of one or more droplets 2602 of the first liquid medium 212 can be pulled from a pen 1016 into the second liquid medium 214 in the second channel 1014. Such a droplet 2602 can then be moved in the second channel 1014 to a location where the droplet 2602 can be analyzed to determine the chemical or material content of the droplet 2602. The content of the first liquid medium 212 in any of the pens 1016 can thus be analyzed by removing one or more droplets 2602 form the pen 1016. The droplet 2602 can be pulled from a pen 1016 into the second channel 1014 and moved in the second liquid medium 214 in the second channel 1014 as discussed above with respect to 20A-21.

As another example, a droplet 2604 containing a biological micro-object 2302 can be pulled from a pen 1016 into the second channel 1014. This can be accomplished in accordance with the process 1100 performed in a pen 1016 and the second channel 1014.

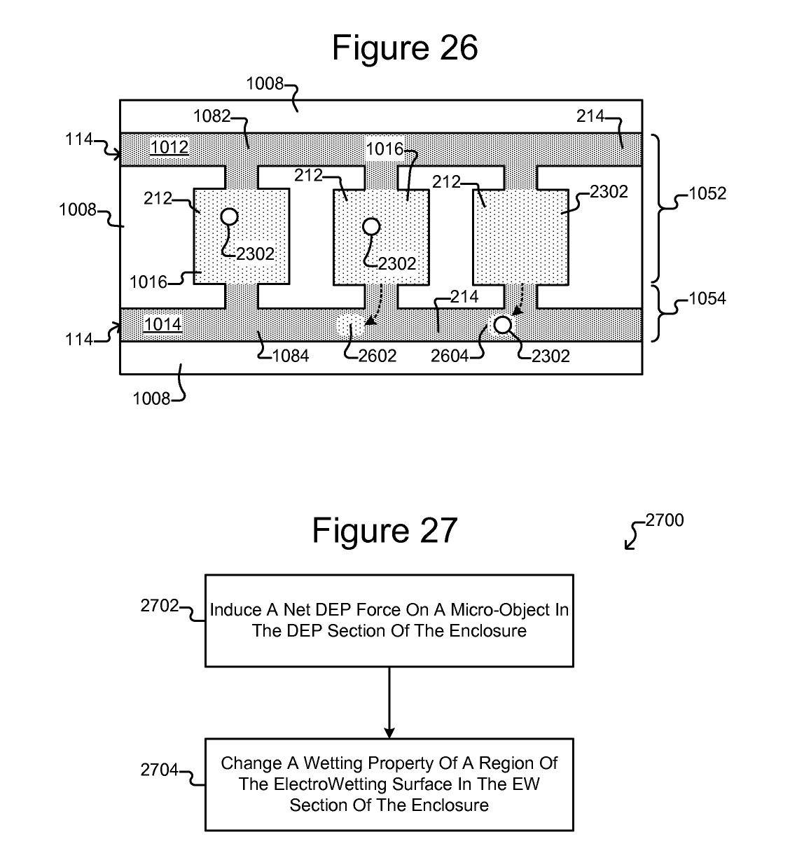

FIG. 27 illustrates an example of a process 2700 that can be performed on a microfluidic apparatus comprising at least one DEP section and at least one EW section. For example, the process 2700 can be performed on the microfluidic apparatus 100 of FIGS. 1A-1C or the apparatus 1000 of FIGS. 10A-10C.

As shown, at step 2702, a net DEP force can be induced on a micro-object in a DEP section of a microfluidic apparatus. For example, the net DEP force F can be induced on the micro-object 228 as illustrated in FIG. 2 and discussed above. The net DEP force F can be sufficiently strong to move the micro-object 228 on the first surface 182. Generally as discussed above, the step 2702 can be repeated for different electrodes 222 at the first surface 182 to move the micro-object 228 along any of a variety of possible paths across the surface 182.

At step 2704, a wetting property of a region of an electrowetting surface in an EW section of the microfluidic apparatus can be changed. For example, a wetting property of the electrowetting surface 184 at an electrode 232 can be changed as illustrated in FIG. 2 and discussed above. The change can be sufficient to move liquid medium (e.g., a droplet of liquid medium) on the electrowetting surface 184. Generally as discussed above, the step 2704 can be repeated for different electrodes 232 at the electrowetting surface 184 to move the liquid medium (e.g., a droplet) along any of a variety of possible paths across the electrowetting surface 184.

The steps 2702 and 2704 can alternatively be performed in any manner discussed herein for inducing a net DEP force on a micro-object or changing a wetting property of an electrowetting surface. Moreover, the steps 2702 and 2704 can be performed simultaneously.

Although specific embodiments and applications of the invention have been described in this specification, these embodiments and applications are exemplary only, and many variations are possible. For example, the DEP configurations (e.g., 122) illustrated in the drawings or described herein are examples. Generally speaking, the DEP configurations (e.g., 122) can be any type of optoelectronic tweezers (OET) devices examples of which are disclosed in U.S. Pat. No. 7,612,355 or U.S. patent application Ser. No. 14/051,004. Other examples of the DEP configurations (e.g., 122) include any kind of electronically controlled electronic tweezers. As another example, the EW configurations (e.g., 124) shown in the drawings or discussed herein are examples. Generally speaking, the EW configurations (e.g., 124) can be any type of optoelectronic wetting (OEW) devices examples of which are disclosed in U.S. Pat. No. 6,958,132. Other examples of the DEP configurations (e.g., 122) include electrowetting on dielectric (EWOD) devices, which can be electronically controlled.

We claim:

1. An apparatus comprising:
an enclosure comprising a first surface and an electrowetting surface;
a dielectrophoresis (DEP) configuration configured to selectively induce net DEP forces in a first liquid medium disposed on said first surface; and
an electrowetting (EW) configuration configured to selectively change a wetting property of said electrowetting surface.

2. The apparatus of claim 1, wherein:
said DEP configuration comprises first electrodes that are spaced one from another and are connectable to a power source; and
said EW configuration comprises second electrodes that are spaced one from another and connectable to a power source.

3. The apparatus of claim 2, wherein said first electrodes are not electrically connected to said second electrodes.

4. The apparatus of claim 2, wherein:
said DEP configuration further comprises a first photoconductive layer disposed between said first surface and one of said first electrodes, wherein illuminating any of a plurality of regions of said first photoconductive layer with a beam of light reduces an electrical impedance of said first photoconductive layer at said illuminated region; and
said EW configuration further comprises a second photoconductive layer disposed between said electrowetting surface and one of said second electrodes and a dielectric layer disposed between said electrowetting surface and said second photoconductive layer, wherein illuminating any of a plurality of regions of said second photoconductive layer with a beam of light reduces an electrical impedance of said second conductive layer at said illuminated region

5. The apparatus of claim 4, wherein:
said dielectric layer is hydrophobic, and
said electrowetting surface is an outer surface of said dielectric layer.

6. The apparatus of claim 4, wherein:
said EW configuration further comprises a hydrophobic coating on said dielectric layer, and
said electrowetting surface is an outer surface of said hydrophobic coating.

7. A process of operating a fluidic apparatus comprising an enclosure for containing liquid media, said process comprising:
inducing a net dielectrophoresis (DEP) force on a micro-object in a first liquid medium on a first surface in a first section of said enclosure; and
changing a wetting property of a region of an electrowetting surface on which a second liquid medium is disposed in a second section of said enclosure.

8. The process of claim 7, wherein said changing comprises changing said electrowetting property of said region of said electrowetting surface on which said second liquid medium is disposed in said second section of said enclosure while simultaneously inducing said net DEP force on said micro-object in said first liquid medium on said first surface in said first section of said enclosure.

9. The process of claim 7, wherein:
said changing comprises changing said wetting property of said region of said electrowetting surface from a first hydrophobic level to a second hydrophobic level, and
said second hydrophobic level is less hydrophobic than said first hydrophobic level.

10. The process of claim 9, wherein said changing comprises changing said wetting property of said region of said electrowetting surface from hydrophobic to hydrophilic.

11. The process of claim 7, wherein:
said process further comprises providing power to first biasing electrodes between which said first liquid medium is disposed,
said inducing comprises changing at a region adjacent said micro-object a voltage drop across a photoconductive material disposed between said first liquid medium and one of said first biasing electrodes from a first value to a second value,
said first value is greater than a corresponding voltage drop across said first liquid medium, and
said second value is less than said corresponding voltage drop across said first liquid medium.

12. The process of claim 11, wherein:
said process further comprises providing power to second biasing electrodes between which said second liquid medium is disposed,
said changing comprises changing adjacent said region of said electrowetting surface a voltage drop across a photoconductive material disposed between said second liquid medium and one of said second biasing electrodes from a first value to a second value,
said first value is greater than a corresponding voltage drop across a dielectric material disposed between said second liquid medium and said insulating material, and
said second value is less than said corresponding voltage drop across said dielectric material.

13. An apparatus comprising:
an enclosure configured to hold a first liquid medium disposed on a first surface in a first section of said enclosure and a second liquid medium disposed on an electrowetting surface in a second section of said enclosure; and
a boundary between said first section and said second section of said enclosure;
wherein:
said first section of said enclosure comprises a DEP configuration configured to induce selectively net dielectrophoresis (DEP) forces in said first liquid medium sufficiently to capture and move, relative to said first surface, micro-objects in said first liquid medium in said first section of said enclosure while connected to a biasing device, and
said second section of said enclosure comprises an electrowetting (EW) configuration configured to change selectively a wetting characteristic of regions of said electrowetting surface sufficiently to move a liquid droplet within said second medium in said second section of said enclosure while connected to a biasing device.

14. The apparatus of claim 13, wherein said boundary comprises a physical barrier located in said enclosure between said first section of said enclosure and said second section of said enclosure.

15. The apparatus of claim 14, wherein said boundary further comprises a passage from said first section of said enclosure through said barrier to said second section of said enclosure.

16. The apparatus of claim 13, wherein at least part of said boundary lacks a physical barrier between said first section of said enclosure and said second section of said enclosure.

17. The apparatus of claim 13, wherein said enclosure comprises:
a first biasing electrode disposed on one side of said enclosure,
a dielectric hydrophobic material disposed on an opposite side of said enclosure,
a second biasing electrode disposed on said opposite side of said enclosure, and
an electrode activation substrate disposed between said dielectric hydrophobic material and said second biasing electrode.

18. The apparatus of claim 17, wherein said electrode activation substrate comprises a photoconductive material.

19. The apparatus of claim 17, wherein said dielectric hydrophobic material is part of said DEP configuration and said EW configuration, and said electrically insulating material is less than ten nanometers thick.

20. The apparatus of claim 17, wherein said dielectric hydrophobic material is part of said EW configuration but not part of said DEP configuration.

21. The apparatus of claim 13, wherein said first surface and said electrowetting surface are disposed substantially in a same plane in said enclosure.

22. The apparatus of claim 13, wherein said enclosure further comprises:
a first sub-enclosure comprising said DEP configuration and said first surface,
a second sub-enclosure comprising said EW configuration and said electrowetting surface, and
a passage from said first sub-enclosure to said second sub-enclosure.

23. The apparatus of claim 22, wherein said first sub-enclosure and said second sub-enclosure are stacked one on top of another.

24. The apparatus of claim 22, wherein said first surface and said electrowetting surface are disposed in a stacked relationship one to another.

25. The apparatus of claim 13, wherein said enclosure comprises:
a first microfluidic channel,
a second microfluidic channel, and
microfluidic pens each connected to said first channel and said second channel.

26. The apparatus of claim 25, wherein:
said first section of said enclosure comprises said first channel, and
said second section of said enclosure comprises said second channel.

27. The apparatus of claim 26, wherein said first section of said enclosure further comprises said pens.

28. The apparatus of claim 27, wherein:
said first channel comprises said first surface of said enclosure but not said electrowetting surface, and
said second channel comprises said electrowetting surface but not said first surface of said enclosure.

29. The apparatus of claim 28, wherein said pens comprise said first surface of said enclosure but not said electrowetting surface.

30. A process of operating a fluidic apparatus having an enclosure that comprises a first surface and an electrowetting surface, said process comprising:
drawing a droplet of a first liquid medium disposed on said first surface in a first section of said enclosure into a second medium disposed on said electrowetting surface in a second section of said enclosure,
wherein said drawing comprises changing an electrowetting characteristic of a region of said electrowetting surface at a boundary with said first surface to induce a sufficient force at said region on said droplet to draw said droplet across said boundary and into said second liquid medium.

31. The process of claim 30, wherein said droplet contains a micro-object.

32. The process of claim 31 further comprising:
selecting said micro-object from a plurality of micro-objects in said first liquid medium, and
moving said selected micro-object in said first liquid medium to said boundary adjacent said region of said electrowetting surface.

33. The process of claim 32, wherein:
said selecting comprises activating electrodes at said first surface of said enclosure to create a net dielectrophoresis (DEP) force sufficient to capture said selected micro-object, and
said moving comprises further activating and deactivating electrodes at said first surface to move said selected micro-object to said boundary adjacent said region of said electrowetting surface.

34. The process of claim 33, wherein said changing comprises activating electrodes at said region of said electrowetting surface.

35. The process of claim 34, wherein said activating said electrodes at said region of said electrowetting surface comprises directing a pattern of light onto said region of said electrowetting surface.

36. The process of claim 33, wherein said activating and deactivating said electrodes at said first surface of said enclosure comprises directing a changing pattern of light onto said first surface of said enclosure.

37. The process of claim 33, wherein said activating and deactivating said electrodes at said first surface of said enclosure comprises directing a changing pattern of light onto said first surface of said enclosure.

38. The process of claim 33, wherein:
said region of said electrowetting surface is adjacent a passage through a physical barrier at said boundary, and
said changing comprises drawing said droplet of said first medium through said passage into said second medium.

39. The process of claim 38, wherein said first surface of said enclosure and said electrowetting surface are spaced apart one from another.

40. The process of claim 39, wherein said first surface of said enclosure and said electrowetting surface are substantially parallel one with another.

41. The process of claim 30, wherein said first surface of said enclosure and said electrowetting surface are located substantially in a same plane.

42. The process of claim 30, wherein:
said first medium is an aqueous medium, and
said second medium is a medium that is immiscible in said aqueous medium.

43. The process of claim 42, wherein said second medium comprises a gas permeable oil.

44. The process of claim 30, wherein:
said first section of said enclosure comprises a first microfluidic channel and microfluidic pens disposed on said first surface of said enclosure,
said second section of said enclosure comprises a second microfluidic channel disposed on said electrowetting surface of said enclosure, and
said process further comprises culturing biological micro-objects in said pens.

45. The process of claim 44, wherein:
said droplet comprises an aliquot of said first medium in one of said pens, and
said drawing comprises drawing said droplet from said one of said pens into said second channel.

46. The process of claim 44, wherein said aliquot comprises biological material from one of said biological micro-objects in said one of said pens.

47. The process of claim 44, wherein:
said droplet comprises one of said biological micro-objects from one of said pens, and
said drawing comprises drawing said droplet from said one of said pens into said second channel.

48. The process of claim 47 further comprising moving said one of said biological micro-objects in said one of said pens to said boundary adjacent said region of said electrowetting surface.

49. The process of claim 48, wherein said culturing comprises moving a droplet of said first medium through said second medium in said second channel into said one of said pens.

50. The process of claim 44 further comprising:
moving said biological micro-objects from said first medium in said first channel into said pens, and
replacing said first medium in said first channel with said second medium.

51. The process of claim 44 further comprising:
moving one of said micro-objects in a droplet of said first medium through said second medium in said second channel to an interface between said first medium and said second medium at an opening to one of said pens, and
moving said one of said micro-objects from said droplet into said first medium in said one of said pens.

52. The process of claim 30, wherein said drawing further comprises inducing a pressure differential between said first liquid medium and said second liquid medium to draw said droplet across said boundary and into said second liquid medium.
